(19) United States
(12) Patent Application Publication
(10) Pub. No.: US 2003/0046344 A1
(43) Pub. Date: Mar. 6, 2003

(54) Method and system for controlling and securing teleconference sessions

(75) Inventors: David Bruce Kumhyr, Austin, TX (US); Samer Farid Najjar, Austin, TX (US)

Correspondence Address: BRACEWELL & PATTERSON, L.L.P., P.O. BOX 969, AUSTIN, TX, 78767-0969, US

(73) Assignee: International Business Machines Corp., Armonk, NY

(21) Appl. No.: 09/944,623

(22) Filed: Aug. 31, 2001

(51) Int. Cl. G06F 15/16

(52) U.S. Cl. 709/205; 709/203

(57) ABSTRACT

A conference session controller connected to user terminals receives signals representing each user accessing an electronic conference session. The session controller assigns each user to a particular class from among a plurality of classes and automatically performs a function to control an aspect of participation in the electronic conference session for each user assigned to a selected class of the plurality of classes. A method comprises initiating the teleconference between participants interconnected by electronic terminals, associating each participant with a class among a plurality of classes, and terminating the teleconference for participants of a selected class, while continuing the teleconference for one or more other classes of the plurality of classes. In this way, a conference leader is provided a way to secure the conference for desired participants with confidence that users of a selected class have been excluded.

### BACKGROUND OF THE INVENTION

1. Technical Field

The present invention relates in general to the field of telecommunications and, in particular, to teleconferencing or videoconferencing. More particularly, the present invention relates to a method and system for controlling an electronic conference session.

2. Description of the Related Art

Often, large manufacturers having multiple plant locations must conduct design team meetings to coordinate the efforts of engineers and designers scattered amongst the different sites. The attendees for these meetings might be geographically dispersed and play different roles in the conference. For professional service firms such as investment banking, brokerages, lawyers, and accountants, meetings are frequently held to discuss various matters. Again, the attendees are frequently from different locations.

It is quite expensive for each individual to physically attend the meeting. Airfare, car rental, and hotel accommodations can be quite expensive. Furthermore, the attendees' valuable time is wasted traveling to and from the meeting site. Moreover, setting up and coordinating the meeting and rescheduling is a time-consuming, complicated and tedious task.

One way for minimizing costs, time, and frustration involves teleconferencing. Teleconferencing is the process of conducting a meeting with a group of attendees simultaneously over the telephone. Thereby, each of the attendees can communicate in real-time, without having to actually be there in-person.

Teleconferencing is initiated in Private Branch Exchange (PBX) telephone systems by a first attendee calling a second attendee; placing that second attendee on hold; calling a third attendee; placing the third attendee on hold; and repeating this process until all the attendees had been accessed. An alternative to PBX teleconferencing has been to utilize service bureau providers or private bridges for multi-site conferencing. Basically, a service bureau provider acts as an intermediary between the different sites, either through an operator or a computerized teleconference bridge. A conference bridge provides a teleconferencing interface between different sites. Before the meeting occurs, an operator assigns a bridge number for that meeting. The bridge number is disbursed to the attendees. At the appointed meeting time, each of the attendees calls a central number to speak with a corporate operator or to directly access the system by dialing a conference number to indicate the particular conference the user is accessing and a password to confirm the user has the necessary permission to participate in the conference call. Once connected, the conference bridge automatically handles all the requisite switching.

Typical prior art teleconferencing systems suffer from several functional drawbacks. Whenever a party logs out of the teleconference, the remaining conferees will want to be apprised of who has left. There tends to be confusion each time someone logs in or out of the teleconference. Often, there is a need to selectively exclude, or disconnect, certain listeners from the call. For example, a conference call might be held between managers and technical leaders of a company to discuss technical matters of the business. During a later portion of the call, the managers may desire to discuss certain business matters without the participation of the technical leaders. The leaders are asked to disconnect to allow the conference to continue without them. This method relies on trust that the non-mangers will actually disconnect as requested. To assure themselves that the conference is secured to managers only is to attempt to listen to the number of disconnect tones emitted by the system and attempt to correlate to the number of people disconnecting. This method is very unreliable and provides very little security that only authorized callers are still on the line. Although an operator can provide relief from these problems, having an operator introduces its own problems of cost, reliability and security.

Thus, there is a need in the teleconferencing prior art for an apparatus and method for providing enhanced features without having to go through an operator. It would be preferable if such a teleconferencing system included some security control to ensure access to selected portions of the teleconference only to authorized parties.

### SUMMARY OF THE INVENTION

To address the above and other shortcomings in the art, the present invention provides a method and system for controlling and securing an electronic teleconference or video-conference.

In accordance with the present invention, a conference session controller connected to user terminals receives signals representing each user accessing an electronic conference session. The session controller assigns each user to a particular class from among a plurality of classes and automatically performs a function to control an aspect of participation in the electronic conference session for each user assigned to a selected class of the plurality of classes. The present invention comprises initiating the teleconference between participants interconnected by electronic terminals, associating each participant with a class among a plurality of classes, and terminating the teleconference for participants of a selected class, while continuing the teleconference for one or more other classes of the plurality of classes. In this way, a conference leader is provided a method to secure the conference for desired participants with confidence that users of a selected class have been excluded.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts an illustrative embodiment of a teleconferencing system with which the method and system of the present invention may advantageously be utilized;

FIG. 2 shows another embodiment of an audio teleconferencing system upon which the present invention may be practiced; and

FIG. 3 depicts a block diagram of one embodiment of the conference server according to a preferred embodiment of the present invention.

FIG. 4 is a diagram illustrating the software architecture of one embodiment of the conference server.

FIG. 5 is a flowchart describing the method of selectively disconnecting users of a selected class, according to a preferred embodiment of the present invention.

### DETAILED DESCRIPTION OF ILLUSTRATIVE EMBODIMENT

In the following description, for purposes of explanation, numerous specific details are set forth, such as voice prompts, passwords, caller options, etc., in order to provide a thorough understanding of the present invention. It will be obvious, however, to one skilled in the art that the present invention may be practiced without these specific details. In other instances, well-known structures and devices are shown in block diagram form and process steps are shown in flowcharts in order to avoid unnecessarily obscuring the present invention. Furthermore, it is readily apparent to one skilled in the art that the specific sequences in which menus and menu items are presented and functions are performed are illustrative and it is contemplated that the sequences can be varied and still remain within the spirit and scope of the present invention.

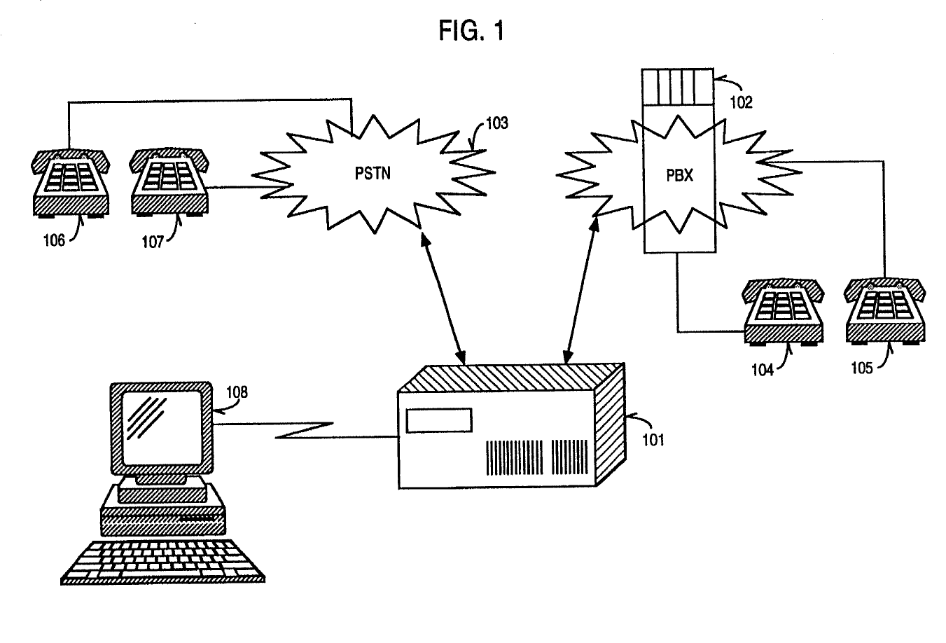

With reference now to the figures and in particular with reference to FIG. 1, there is shown an illustrative embodiment of an audio conferencing system with which the method and system of the present invention may advantageously be utilized. Referring to FIG. 1, a conference server 101 is a piece of customer premise equipment that is coupled to a PBX 102 or Centrex system via a standard trunk connection. The conference server can also be coupled to a Public Switched Telephone Network (PSTN) 103. In one embodiment, one or more personal computers 108 interconnected in a local area network are coupled to the conference server 101 for providing enhanced functionalities. It is through the conference server 101 that teleconferencing is provided. Thereby, users on telephone sets 104-107 can communicate with one another in an audio teleconference. Telephone sets 104-107 and computers 108 may hereinafter be referred to as terminals.

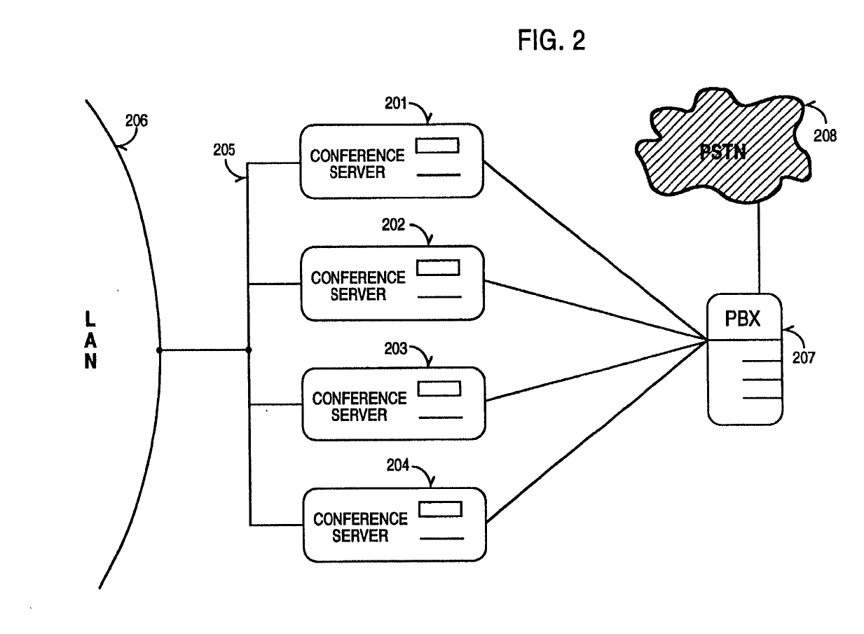

FIG. 2 shows another embodiment of an audio teleconferencing system upon which the present invention may be practiced. It can be seen that multiple conference servers 201-204 can be interconnected to form a single, integrated system having a large number of ports. This provides for expandability. The integration is accomplished by extending a data and a control path 205 from LAN 206 to each of the conference servers 201-204. In turn, each of the conference servers is connected to the PBX 207 and PSTN 208. This allows for gradual degradation of service if an individual conference server fails.

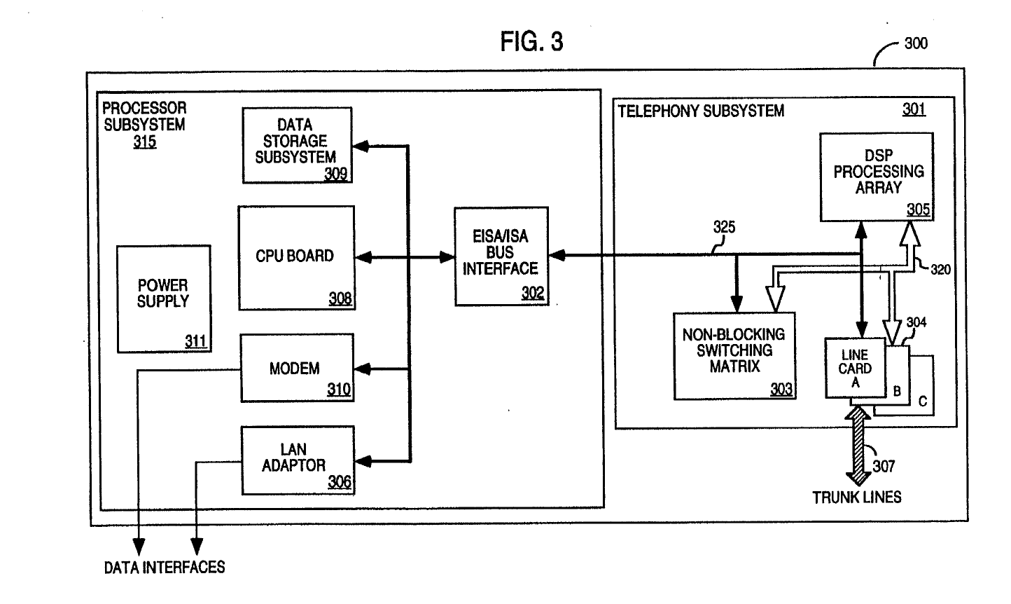

In the currently preferred embodiment, the conference server unit is a single mechanical assembly capable of being mounted in a rack, stood on the floor in a tower configuration, or placed on a desktop. A block diagram of one embodiment of the conference server is shown in FIG. 3. The conference server 300 is comprised of a telephony subsystem 301 having a non-blocking switching matrix 303, line cards 304, a DSP processing array 305 and a switching matrix bus 320.

Switching matrix 303 is a multi-port, full duplex, time switched and non-blocking cross-point switch for routing voice signals received from and transmitted to incoming trunk lines 307 via the line cards 304 and the DSP processing array 305. Preferably, both analog and digital trunk connections are supported. The voice signals are transferred between the line cards 304 and the DSP processing array 305 over the switching matrix bus 320.

The DSP processing array 305 includes multiple, programmable DSP engines (e.g., TMS320, manufactured by Texas Instruments, Inc.) for compressing voice to/from 32 KBPS for storage/playback. For example, when a caller is to join a conference, the spoken name of the caller is retrieved from memory for playback to the conference participants as part of the announcement. In addition, the system provides the capability to record a teleconference. Thus, the DSP processing array 305 receives the voice data representative of the recording, compresses the voice data for subsequent storage. The DSP engines are also used to detect DTMF tones when an attendee or caller depressed keys on a touch tone phone, provide automatic gain control of voice signals which arrive on incoming trunks 307, power limit outgoing audio which output to the trunk lines 307 and detect and eliminate noise and any silence which occurs during recording.

In addition, the DSP processing array 305 performs the mixing of voice signals to provide conferencing of participants. For example, the non-blocking switching matrix 303 causes voice signals received from a first conference participant through a first line card 304 and voice signals received from a second conference participant through a second line card 304 to be transferred to the DSP processing array over the switching matrix control bus 320. The DSP processing array 305 mixes the first and second voice signals. The switching matrix 303 receives the mixed signals provides the voice signals of the first and second participants to the line card 304 connecting to a third conference participant such that the third participant hears the voices of the first and second participants.

The telephony subsystem is connected to a processor subsystem which provides control signals for operation of the conferencing system. For example, processor subsystem 315 instructs switching matrix 303 as to which voice signals are to be mixed and connected to a particular line card coupled to an identified participant. The processor subsystem 315 is connected to the telephony subsystem 301 via a processor control bus 325 and EISA/ISA bus interface 302. Preferably, the bus interface 302 supports a multi-slot PC standard bus architecture, so that off-the-shelf CPU and telephony line cards can be incorporated.

The central processing unit (CPU) board 308 contains one or more microprocessors and RAM and is used to control conference server functions, such as telephone line card operations, management of system databases, such as the scheduling conference database and user profiles database discussed herein, coordination of call processing within the DSP processing array, support of maintenance access, and communication with an administrative PC coupled to the server.

System software, audio prompts, and system and user database information are stored in the data storage subsystem 309. A modem 310 is implemented to provide for a dial-in connection to the processor subsystem 315. For example, this enables remote support of the server to be provided. Power supply 311 is used to convert incoming 110 VAC to the voltage needed to power the conference server 300. The LAN adapter 306 is used to interface with LAN/WAN (e.g., Ethernet or 10 Base T) connections for coupled devices such as an Administrative PC, modem connections for remote support, and RS232 serial port interfaces for system debug.

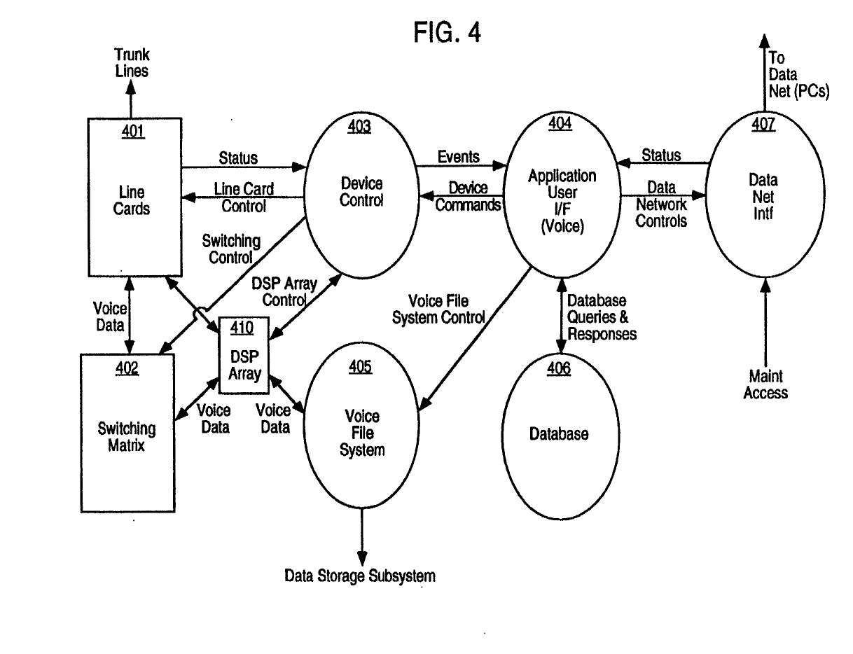

FIG. 4 is a diagram illustrating the software architecture of one embodiment of the conference server. Referring to FIG. 4, the conference server software includes the following integrated modules: device control module 403, application user interface module 404, voice file system module 405, database module 406 and data network interface module 407.

The device control module 403 is coupled to the line cards 401, switching matrix 402 and the DSP 410 to issue control signals to control the devices 401, 402, 410. For example, the device control module 403 issues the proper control signals to switching matrix 402 to perform the switching to route the voice signals among the line cards 401 and the DSP array 410. The device control module 403 also receives status information from the line cards 401 and DSP array 410 and includes call processing software to interpret telephone network activity (e.g., incoming seizure, far end disconnect) received from the line cards 401 and user input DTMF tones, detected by the DSP array 410. In response to telephone network activity, the device control module 403 issues events to the user application module 404.

The user application module 404 is viewed as the central module which controls the operations performed by the teleconferencing system. The user application module responds to user input, received as events from the device control module 403, to invoke the features of the system, such as the role assignment feature, described herein. In addition, the user application module 404 interfaces with the database module 406 and voice file system 405 to store voice prompts and spoken names of users and to retrieve and play back the prompts and spoken names during operation of the system.

The voice file system 405, controlled by the user application module 404, stores and outputs voice data. More particularly, the voice file system 405 is coupled to the DSP array 410 and memory and enables real time support of a multi-port voice subsystem providing simultaneous playback and record operations as part of the automated teleconferencing services described herein. For example, when a caller wishes to join a teleconference, the spoken name of the caller is retrieved by the voice file system from the data storage subsystem and output to the DSP array 410. The DSP array 410 processes the name and outputs the signals subsequently through the switching matrix 402 to line cards 401 for communication of a verbal announcement to the conference participants that the caller, identified by the spoken name, is joining the conference.

The system includes a configurable database 406, preferably stored in a data storage subsystem, which is accessed by the user application module 404 to operate the system. The database typically includes system information that controls the operation of the hardware and software of the server and the interface between the system and the telephone network. In addition, the database includes company specific information that records administrative information and scheduling/usage parameters. In one embodiment the system information includes network parameters regarding data network addresses used by the server. Telephone access information that determines the type of services available to the caller is also included.

The database also includes user profiles. Preferably, each user profile is distinguished by a user ID. Each user profile contains information that identifies the user preferences as to how the teleconferencing system is to operate when the user schedules a conference. For example, the user profile will contain the user's preferences regarding the enabling and disabling of certain features of the teleconferencing system. Thus a teleconference can be scheduled easily by a user. Furthermore, each user profile also includes a pointer to the user's spoken name accessed through the voice file system 405. Preferably, when a user profile is established, the system prompts the user to speak his/her name to the system whereby the system records the user's spoken name for subsequent playback during the generation of certain announcements. Each user profile identifies a user to the server and classifies the type of access the user requires. Furthermore, the classification identified in the user profile determines the features of the server that are available to the user.

The user's spoken name, utilized by the system to announce the entrance of each caller to the other conference attendees, is identified by accessing the user's profile. In particular, if a caller is to join a conference, the user application module 404 queries the database module 406 for the user's profile. The profile is identified by a user ID, preferably entered by the caller by generating DTMF tones which are detected by the DSP array 410, communicated to the device control module 403 and to the user application module 404. Once the user profile is accessed, the database module 406 provides the pointer to the user's spoken name. This pointer is provided by the user application module 404 to the voice file system module 405 with a command to generate the announcement of the caller joining the conference. The voice file system module 405 responds by retrieving the announcement and the spoken name from the voice data storage, outputting the voice data to the DSP array. The DSP array 410, under control of device control module 403, decompresses the data and outputs the data to the switching matrix 402, which is instructed by the user application module 404, via the device control module 403, to switch the voice data to the line cards 401 corresponding the conference participants so that the conference participants hear the announcement. In some situations, announcing the user's name would be impractical, impossible or undesirable, for example such as when the conference has many users, the user's name is not available or anonymity is desired. In such cases, the system could announce the user with some other identifier such as the user's role or class.

The data network interface module 407 provides network connectivity to the administrative PC and allows database access and update from an external workstation.

In the currently preferred embodiment, there are up to 120 ports that are available for audio conferencing in a single system. These ports can be utilized in any combination of conferences and any number of attendees. For example, the system at any time many accommodate a single conference with 120 attendees or 30 different conferences with four attendees each. The hardware/software architecture described above allows for dynamic port allocation with minimal limits on the number of calls or the number of conferees per call.

The current preferred embodiment performs three basic functions: identifying users and providing them access to a conference call, defining a role for each user on the conference call, and controlling participation in the conference call for selected roles, preferably under the control of the conference leader. In a preferred embodiment, both the leader and the users are provided with a single phone number to access the conference, including certain privileged functions which are available through a menu navigated through by the user through the generation of certain DTMF tones. The integrated switching matrix allows a caller to be connected to any resource, another trunk, voice processing or to an operator. Callers are guided through the conferencing system by a series of prerecorded verbal prompts. Callers use DTMF touch-tone inputs to select options and input information to the audio conferencing system. Although a live operator is not required in order for a user to schedule or attend a conference, the system can be configured to designate access to a live operator as there may be instances when callers would find it more convenient to have outside assistance. For instance, a user might forget the meeting identification number or if there are scheduling conflicts.

Initially, a user calls a number defined as a “profile” in the system database. The profile acts as a user account identifying the user and providing customized information and functions, where users can use their telephones to schedule a conference, select a conference to attend, manage recorded voice segments, and perform basic administrative functions such as changing their password.

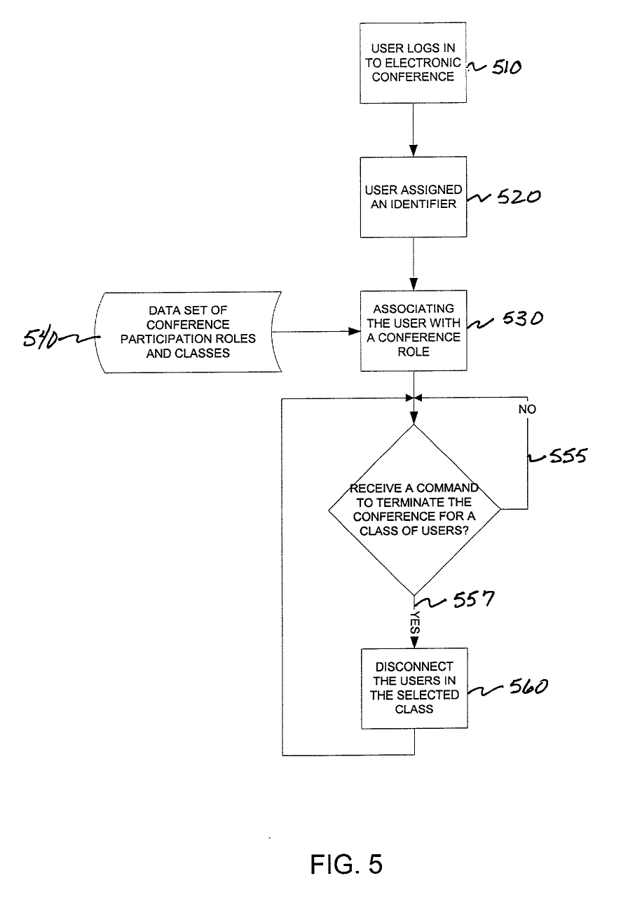

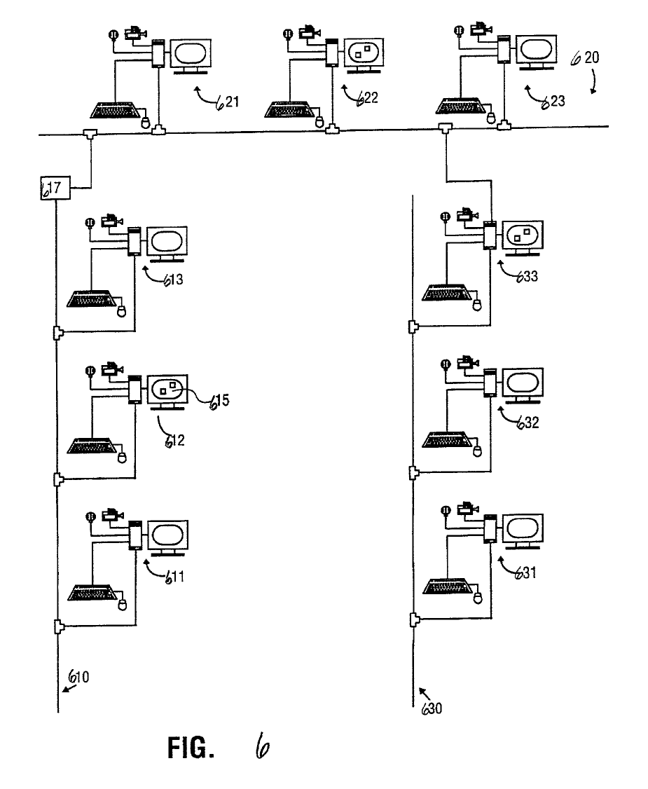

FIG. 5 is a flowchart describing the method of selectively disconnecting users of a selected class, according to a preferred embodiment of the present invention. Initially, a user logs in to the teleconference, as shown in step 510. The caller calls the system and is greeted with a customized recording, such as “Welcome to the XYZ System.” The caller navigates through the system by entering in DTMF codes using the user's touch-tone telephone. The system first prompts the caller for a profile identification number. The system also prompts the caller for a password (if required). The user enters the profile number and password by pressing the appropriate touch tones on the telephone which cause the generation of the DTMF codes. The system may optionally confirm the profile and/or password with the caller. A user having the appropriate password and user ID is granted access to the teleconference.

Once the user has been successfully logged into the electronic conference, the user is assigned an identifier in step 520. This identifier will usually be the profile identification number or “user ID”, which the user had entered as part of the procedure for gaining access to the electronic conference and uniquely identifies the user.

The process then continues with the step 530 of associating the user with a conference “role”. Every user accessing the conference will have a conference role, indicating what role the caller will have in the call. Each role falls within a class of roles, and a teleconference will be conducted between a number of classes. A class can be defined as including a single role or multiple roles, as is necessary or convenient. For example, a conference call between employees from a particular company might have different participants representing different classes within the organization. In this example, the employees could be classified based on their department, managerial level, or geographic location. A user of the conference might have a defined role of an engineering senior manager in Texas, U.S.A., for example, and be placed in three classes of participants—an “engineering” class, a “senior manager” class and a “Texas” class. In an alternative example, a user's role is defined as a “manager,” and the user's class includes only that role.

In step 530, the system associates a user with a particular class based on the user's profile or user ID or password entered upon gaining access to the teleconference. The system of the preferred embodiment would access a data set of conference participation roles and classes 540. These participation roles and classes would be predefined and input into data set 540. The leader of the conference call may also have authorized access to the data set to create or modify new roles and classes. The system automatically associates the user with a particular conference participation role based on the user's profile, user ID, password, or inputs from the conference leader, thereby automatically associating the user with one or more classes correlated with the conference participation role, as defined by data set 540. In this way, it can be seen that as each user logs into the conference and is identified, the user is also placed within a predefined class(es). As an example, a group of users could be given the same password to the conference. Thereafter, the leader could disconnect all the users of that group by commanding the disconnect of their associated class. This would provide the leader a method to secure the conference for the desired participants with confidence that the user given the particular password have been excluded. Referring to FIG. 1, conference server 101 would assign each user to a particular role from the among the selected roles provided in data set 540.

Referring back to FIG. 5, the process proceeds to decision block 550, where the conference system waits (through path 555) to receive a command code to terminate the conference for a particular class of users. In a preferred embodiment, the leader of the conference call will have the capability of entering such command codes into the system by entering touch tones on the telephone, which causes generation of DTMF codes, or directly typing commands into a computer terminal connected to the conference system. In a preferred embodiment of the present invention, the leader enters a command to terminate a selected class of users from further participation in the conference call.

When a command is received at decision block 550, the flow continues through path 557 to step 560 where the conference controller performs the command to control an aspect of participation in the electronic conference for each user assigned to the selected class. In the preferred embodiment, in response to receiving the command, conference controller 101 disconnects the electrical connection between users in the selected class and the rest of the teleconference, as shown in step 560.

In alternative preferred embodiments of the present invention, the leader may have a variety of commands that control different aspects of participation in the electronic session for those users having a particular role in the conference. For example, the leader may choose to temporarily disable the audio-portion of an electronic connection between a selected class and the rest of the participants in the electronic conference. This function is sometimes called “muting”. Thus, as an alternative example to above, if conference controller 101 receives a command at block 550 to mute the conference for a selected class of users, conference controller 101 would temporarily disable the audio-portion of the electrical connection between the users associated with the selected class and the rest of the participants in the conference at step 560. At this point the leader might issue a command to feed the muted users other information/data, such as music or participation in a different conference, until such time as the leader wanted to rejoin them. Session controller 101 might then receive a different command at decision block 550 requesting that the audio-portion of the conference for the selected class be re-established. At step 560, conference controller 101 would re-establish the audio-portion of the conference call for the selected class of users.

In an alternative implementation of an alternative embodiment of the present invention, the electronic conference is a video conference having both an audio-portion and a video-portion creating an audio-video connection between the user's terminals, thereby allowing a teleconference to be conducted with the users viewing a television image of each of the participants. In this preferred embodiment, the leader may have the capability of muting the audio participation of a particular class of users, while maintaining visual participation in the conference for the selected class via the continuing video-portion of the communication.

The leader of the conference will typically have the role of leading and controlling the conversation between the users and thus, would be in the best position to control the participation of each class or participant. In other situations, the leader might not be a participant in the teleconference, but would still have the capability of issuing the command to terminate selected classes from the conference. In an alternative preferred embodiment of the present invention, the conference controller would automatically issue commands to terminate the connection to the conference for selected users. The conference controller would issue the command to terminate based on a given conference reaching predefined criteria such as expiration of a time frame, number of participants connected to the conference, or user's level-of-authorization (as indicated by the user's profile, for example).

The use of digital processing systems, such as general purpose computer systems, to conduct a meeting by “videoconference” is becoming popular. Typically, a computer program, referred to as a teleconferencing application, is run on each computer system involved in the videoconference. Each program typically causes its system to capture images and sound recordings from the user of the system and to transmit this data to the other systems. Moreover, each program typically causes its system to display the transmitted images from the other systems and to reproduce the transmitted sound recordings from the other systems. As explained above, an alternative preferred embodiment of the present invention is implemented on a videoconference. FIG. 6 shows a videoconference system suitable for practicing the invention. Computer systems, servers, work stations, and other machines may be connected to one another across a communication medium including, for example, a network or networks. For simplicity of explanation, the term “communication medium” refers to any medium for communicating including conductors (e.g., common carrier telephone lines) or wireless media (e.g., electromagnetic transmissions) and includes simple point to point systems (e.g., a first modem coupled to a telephone line which is coupled to a second modem) or complex systems where communications originate from a computer in a first LAN (Local Area Network), transit through router systems and/or gateway systems, to a second computer on a second LAN. The term communication medium also refers to the network of networks referred to as the Internet.

FIG. 6 shows three computer systems (terminals) 611, 612, and 613 and a router 17 coupled to a network 10, and three computer systems (terminals) 621, 622, and 623 coupled to another network 20, and another three computer systems (terminals) 631, 632, and 633 coupled to another network 630. As shown in FIG. 6, a number of computer systems coupled via a network may each have a teleconferencing application running thereon. A teleconferencing application 615 running on one computer system 612 sends teleconferencing messages over the networks to the teleconferencing applications running on the other computer systems 622 and 633 that are participating in the same teleconference. As will be appreciated by those skilled in the art, computer system 612 performs additional system functions consistent with controller 101 for implementing this preferred embodiment of the present invention. One computer system on a network may have running thereon a teleconferencing application that is engaged in more than one teleconference simultaneously. Some computer systems on the networks are not engaged in any teleconferencing. A network may be a local network connecting a few machines to one another, or a much wider network connecting large numbers of different types of machines. Many networks, especially wide area networks, connect machines operating on different platforms with different operating systems and different microprocessors, but provide consistent protocols to allow the machines to communicate. Various approaches to networking are known in the art, including distributed networks and centrally administrative networks.

While the invention has been particularly shown and described with reference to a preferred embodiment, it will be understood by those skilled in the art that various changes in form and detail may be made therein without departing from the spirit and scope of the invention.

What is claimed is:

1. A method for controlling an electronic conference session between a plurality of terminals, said method comprising:
assigning an identifier to each terminal among a plurality of terminals;
associating at least one identifier with a particular class of terminals among a plurality of classes; and
thereafter, automatically controlling an aspect of participation in the electronic conference session for each terminal of the plurality of terminals assigned with an identifier associated with the particular class.

2. A method according to claim 1, wherein the electronic conference session is a teleconference and at least one of the plurality of terminals includes a telephone.

3. A method according to claim 1, wherein the electronic conference session is a video-conference and at least one of the plurality of terminals includes a video monitor.

4. A method according to claim 1, wherein the step of controlling comprises controlling an aspect of participation in the electronic conference session for two or more terminals of the plurality of terminals having identifiers associated with the designated class.

5. A method according to claim 1, further comprising the step of providing a terminal among the plurality of terminals with access to the electronic conference session in response to receiving an identifier for the terminal.

6. A method according to claim 1, wherein the identifier represents a role in the electronic conference session for a user of the terminal.

7. A method according to claim 1, wherein the step of controlling includes modifying an electronic connection between two or more terminals among the plurality of terminals.

8. A method according to claim 7, wherein the step of modifying includes terminating the electronic connection.

9. A method according to claim 7, wherein the electronic connection is an audio-visual connection and the step of modifying includes terminating an audio portion of the audio-visual connection.

10. A method according to claim 7, wherein the electronic connection is an audio-visual connection and the step of modifying includes terminating a video portion of the audio-visual connection.

11. A system for controlling an electronic conference session among a plurality of terminals, said system comprising:
a controller connected to the plurality of terminals that receives signals representing each user accessing the electronic conference, wherein the session controller assigns each user to a particular class from among a plurality of classes and performs a function to control an aspect of participation in the electronic conference for each user assigned to a selected class of the plurality of classes.

12. A system according to claim 11, wherein the plurality of terminals are connected by one or more communication paths, each of the plurality providing a user access to the electronic conference via at least one communication path of the one or more communication paths, along which signals representing the user can be transmitted.

13. A system according to claim 11, wherein the electronic conference is a teleconference and the plurality of terminals includes a telephone.

14. A system according to claim 11, wherein the electronic conference is a videoconference and the plurality of terminals includes a video monitor.

15. A system according to claim 11, wherein the controller assigns each user to a particular class from among a plurality of classes in response to the signals.

16. A system according to claim 11, wherein the function includes modifying one or more communication paths of the one or more communication paths between two or more terminals of the plurality of terminals.

17. A system according to claim 11, wherein the function includes disconnecting one or more communication paths of the one or more communication paths.

18. A method for controlling participation in a teleconference, said method comprising:
initiating the teleconference between a plurality of participants interconnected by electronic terminals;
associating each participant of the plurality of participants with a class among a plurality of classes; and
terminating the teleconference for participants of a selected class, while continuing the teleconference for one or more other classes of the plurality of classes.

19. A method according to claim 17, wherein the step of associating includes associating as a function of a code entered into an electronic terminal by a participant as part of a process for gaining access to the teleconference.

20. A method according to claim 17, wherein the step of terminating includes selecting the selected class as a function of a code entered into an electronic terminal by a leader.

21. A method according to claim 19, wherein the leader is one of the plurality of participants.

22. A program product for controlling participation in a teleconference comprising:
a computer-readable medium;
a controller function encoded in the computer-readable medium, the controller function comprising the steps of:
initiating the teleconference between a plurality of participants interconnected by electronic terminals;
associating each participant of the plurality of participants with a class among a plurality of classes; and
terminating the teleconference for participants of a selected class, while continuing the teleconference for one or more other classes of the plurality of classes.

23. A program product according to claim 21, wherein the step of associating includes associating as a function of a code entered into an electronic terminal by a participant as part of a process for gaining access to the teleconference.

24. A program product according to claim 21, wherein the step of terminating includes selecting the selected class as a function of a code entered into an electronic terminal by a leader.

25. A program product according to claim 21, wherein the leader is one of the plurality of participants.
